(19) United States
(12) Patent Application Publication
(10) Pub. No.: US 2022/0253852 A1
(43) Pub. Date: Aug. 11, 2022

(54) System and method for processing payment transactions via blockchain network

(71) Applicant: Eland Blockchain Fintech Inc., San Jose, CA (US)

(72) Inventors: Ching Song WU, Taipei City (TW); Chih Sheng WANG, New Taipei City (TW)

(21) Appl. No.: 17/610,463

(22) PCT Filed: Jun. 24, 2020
(86) PCT No.: PCT/US2020/039272

§ 371 Date: Nov. 11, 2021

Related U.S. Application Data
(60) Provisional application No. 62/866,703, filed on Jun. 26, 2019.

(51) Int. Cl. G06Q 20/40; G06Q 20/06; G06Q 20/08; G06Q 20/38; H04L 9/06; H04L 9/40

(52) U.S. Cl. CPC G06Q 20/4014; G06Q 20/065; H04L 63/126; G06Q 20/3827; H04L 9/0637; G06Q 20/0855

(57) ABSTRACT

The invention discloses a system and method for processing a payment transaction via a blockchain network. The method includes: providing a payment transaction message that includes a payer identity data item, a transaction amount, and a recipient account data item; sending the payment transaction message to an intermediary processing node through a recipient node; verifying the received identity data item by the intermediary processing node, and then sending the payment transaction message to a payer account node; confirming the identity data item and transaction amount by the payer account node, and sending a payment transaction confirmation message to the intermediary processing node; broadcasting the payment transaction message to the blockchain network by the intermediary processing node or the recipient node.

### BACKGROUND OF THE INVENTION

### 1. Field of the Invention

The present invention relates to a system and method for processing payment transactions through a blockchain network, in particular to a method and system for processing and storing payment transactions using a blockchain network.

### 2. Description of the Related Art

Current payment transactions are nothing more than cash transactions, credit card transactions, and mobile payments (third-party payment platforms), among which credit card transactions and mobile payments are still incapable of avoiding “centralized model.”

In a “centralized model”, both the payer and the recipient must process their transactions through a third-party transaction processing mechanism. The risk is extremely high. If there is a problem with the third-party transaction processing institution, the transaction may be interrupted and fail, at worse the entire asset may even vanish, and the privacy of the transaction message may not be secured.

Now, reference is made to FIGS. 5A and 5B. FIG. 5A is a diagram showing an existing architecture system for credit card transactions, and FIG. 5B is a credit card transaction flowchart of the known type. The following descriptions shall be made based on, for example, credit card transactions. Firstly, in the step S1, the consumer makes his credit card payment at the merchant. In the step S2, the merchant's point of sale (POS) information system transmits this card transaction message to the acquiring bank AB. In the step S3, the acquiring bank AB transmits this credit card transaction message to the Card Association, which is the “third-party transaction processing institution Pt” mentioned hereinbefore, and is commonly known as VISA, Mater Card, JCB, etc. In the step S4, the Card Association transmits the credit card transaction message to the card issuing bank IB, which confirms the credits of the consumer and processes the transaction, and then in the step S5, makes a response to the Card Association. In the Step S6, the Card Association sends a confirmation message to the acquiring bank AB after having recorded the transaction. In the Step S7, the acquiring bank makes a confirmation to the merchant's point of sale (POS) information system identifying that the card payment is successful. Finally, the card issuing bank 1B sends the bill to the consumer for payment, as in steps S8 and S9.

However, as shown in the architecture diagram shown in FIG. 5A, the existing credit card payment architecture adopts a centralized model, in which a third-party transaction processing institution Pt is connected to a plurality of card issuing banks IB and a plurality of acquiring banks AB at the same time. As the transaction flowchart of FIG. 5B shows, the existing credit card payment process is considerably complicated. A single transaction message has to go through multiple processing nodes, and each processing node incurs a considerable service fee, resulting in high transaction costs. Further, the privacy of the transaction is unsecured.

### SUMMARY OF THE INVENTION

The object of the present invention is to provide a system and method for processing a payment transaction through a blockchain network, which may simplify the architecture and process of a payment transaction by adopting the decentralized nature of the blockchain network, so that the payer and the recipient can conduct the transaction directly. In addition, in view of the nature of the blockchain network, the payment transaction is open, transparent, and non-repudiable.

To achieve the above object, the present invention provides a system for processing payment transactions via a blockchain network having at least one recipient node, at least one payer account node, and an intermediary processing node, wherein the intermediary processing node includes a processor, a memory module configured to store at least one application program, and a network interface, wherein the at least one application program includes a plurality of processer-executable instructions that, when executed by the processor, cause the processor to perform a process comprising: receiving from the at least one recipient node via the network interface, a payment transaction message including a payer identity data item of a payer making a payment, transaction amount, and a recipient account data item; verifying the payer identity data item and then transmitting at least the payer identity data item and the transaction amount included in the payment transaction message to the at least one payer account node; and after receiving, via the network interface, a payment transaction confirmation message sent by the at least one payer account node, either broadcasting the payment transaction message to the blockchain network, or sending the payment transaction message to the at least one recipient node by which the payment transaction message is broadcasted to the blockchain network.

To achieve the foregoing objective, a method for processing a payment transaction via a blockchain network of the present invention comprises: a step (A) of providing a payment transaction message to a recipient node in the blockchain network, the payment transaction message including a payer identity data item of a payer making a payment, a transaction amount, and a recipient account data item; a step (B) of sending, by the recipient node, the payment transaction message to an intermediary processing node in the blockchain network; a step (C) of verifying, by the intermediary processing node, the payer identity data item, and then transmitting at least the payer identity data item and the transaction amount included in the payment transaction message to a payer account node in the blockchain network; a step (D) of confirming, by the payer account node, the payer identity data item and the transaction amount, and then sending a payment transaction confirmation message to the intermediary processing node; a step (E) of either broadcasting, by the intermediary processing node, the payment transaction message to the blockchain network, or sending, by the intermediary processing node, the payment transaction message to the recipient node, and broadcasting, by the recipient node, the payment transaction message to the blockchain network.

In view of the forgoing, it is apparent that in the system and method according to the present invention, the intermediary processing node only verifies the payer identity data item. After verification, the payment transaction message is confirmed by the payer account node, which is normally based on the credit or account balance of the payer. When the payer account node acknowledges the confirmation, it means that the payment transaction is a legal transaction. Then, the intermediary processing node broadcasts the transaction message to the blockchain network. Finally, the payer account node, the recipient account node or some other account nodes make the payment request, reconciliation, and appropriation based on the transaction message.

### BRIEF DESCRIPTION OF THE DRAWINGS

FIG. 1A is a flow chart illustrating an exemplary method for processing a payment transaction according to a preferred embodiment of the present invention.

FIG. 1B is a diagram illustrating a system architecture according to a preferred embodiment of the present invention.

FIG. 2A is a diagram schematically illustrating a first transaction mode of a preferred embodiment of the present invention.

FIG. 2B is a diagram illustrating a system architecture used in a first transaction mode of a preferred embodiment of the present invention.

FIG. 2C is a diagram schematically illustrating another signature method of a preferred embodiment of the present invention.

FIG. 3A is a diagram schematically illustrating a second transaction mode of a preferred embodiment of the present invention.

FIG. 3B is a drawing illustrating a system architecture of a second transaction mode according to a preferred embodiment of the present invention.

FIG. 4 is a drawing illustrating a system architecture of a third transaction mode of a preferred embodiment of the present invention.

FIG. 5A is a drawing illustrating an existing system architecture for credit card transaction.

FIG. 5B is a flow chart illustrating a conventional method for processing a credit card transaction.

### DESCRIPTION OF THE PREFERRED EMBODIMENTS

The present invention is related to a system and method for processing payment transactions via a blockchain network. In the description, similar elements will be denoted by the same reference numerals. In addition, the drawings of the present invention are only intended to be illustrative, and are not necessarily drawn to scale, and all details are not necessarily be shown in the drawings.

For illustrative purpose, the embodiments described hereinafter are mainly based on credit card payment transactions. However, the descriptions on the preferred embodiments are only intended to be illustrative, and the present invention shall not be limited to credit card payment transactions. The system or method of the present invention is applicable to any carrier that may record or store information for verifying the identity of the payer, any mechanism or organization that may store fiat or virtual currency, or any mechanism or organization that may pay for the payer's debt or pay in advance the payer's debt, such as debit cards, ATM cards, pre-paid cards, value-added cards, etc.

The present invention is also applicable to any Staff ID card with liabilities secured by the company's financial department, and any membership card with liabilities secured by the card issuer. Further, the present invention is also applicable to room cards for hotels or cruises for consumption purposes. The above-mentioned carriers are not limited to those in the form of a card. This invention is applicable to any carrier that can be used to identify the identity of the payer, for example a mobile phone, or any device implanted with identity information, or even identify the identification directly on biological characteristics, such as fingerprints, veins, iris, face, voiceprint, DNA, etc.

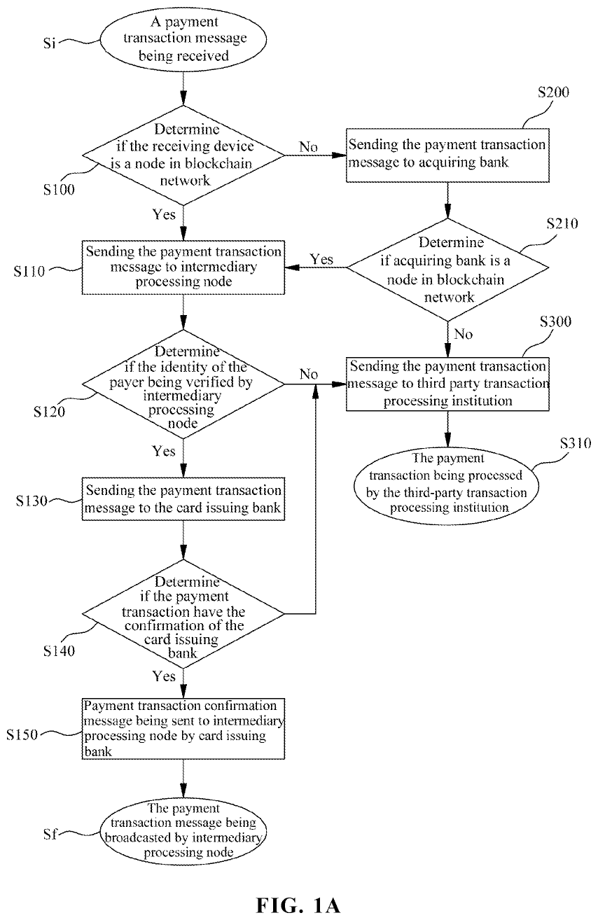

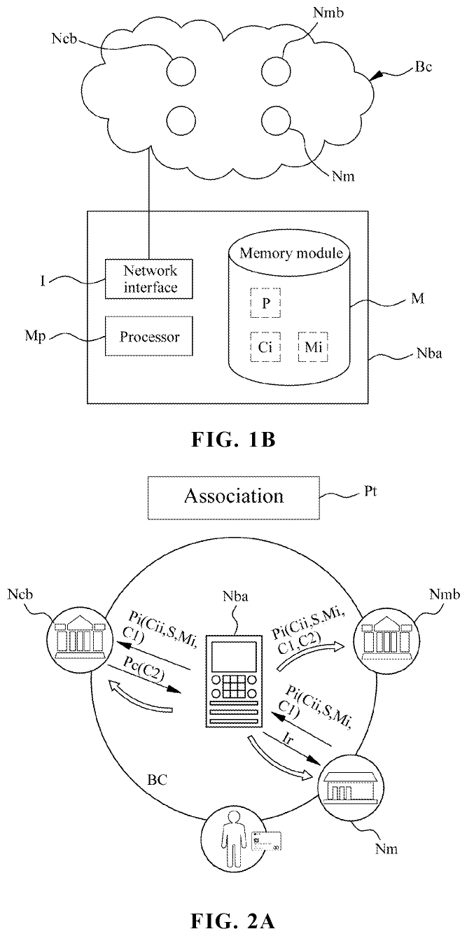

FIG. 1A is a flow chart illustrating an exemplary method for processing a payment transaction according to a preferred embodiment of the present invention. The overall transaction process according to this embodiment is described hereinafter. Firstly, in the step Si, the receiving device (credit card machine) of the recipient (seller, merchant) receives a payment transaction message. Then, in the step S100, if the receiving device is a node in the blockchain network, the first transaction mode is executed. If the receiving device is not a node in the blockchain network, the second transaction mode is executed. The first and second transaction modes will be described in detail hereinafter.

In the first transaction mode, the receiving device first transmits the payment transaction message to an intermediary processing node within the blockchain network (step S110) so that the identity of the payer is verified by the intermediary processing node (step S120). If verification of the identity of the payer fails, a notification is sent to the receiving device which then sends the payment transaction message to a third-party transaction processing institution (such as VISA, Master, JCB, etc.) through the acquiring bank, and proceeds with the conventional credit card transaction process, as in the step S300. If verification of the identity of the payer is successful, the payment transaction message is transmitted to the payer issuing bank, as in the step S130.

Next, in the step S140, the card issuer needs to confirm the payment transaction message. If confirmation of the payment transaction message by the card issuer fails for the reasons such as lack of credibility or insufficient deposit, a notification message is sent to the receiving device through the intermediary processing node, and proceeds with the traditional credit card transaction process, as in the step S300. In an alternative embodiment, the intermediary processing node may notify the receiving device that the credit card payment fails, and cancel the transaction. If the confirmation of the payment transaction message by the card issuing bank is successful, the card issuing bank sends a payment transaction confirmation to the intermediary processing node, as in the step S150. Finally, the intermediary processing node broadcasts the payment transaction message to the blockchain network, as in the step Sf.

The second transaction mode is based on the condition that the receiving device is not a node in the blockchain network while the acquiring bank is a node in the blockchain network. Needless to say, at the beginning of the overall process, it is still necessary to determine whether or not the acquiring bank is a member of the system. In the step S200, the acquiring bank receives the payment transaction message. In step S210, if the acquiring bank is a node in the blockchain network, the step S110 is carried out, and then the step S120 to the step Sf are carried out. If the acquiring bank is not a node in the blockchain network, the step S300 is carried out, the payment transaction message is transmitted to a third-party transaction processing institution by which the payment transaction is handled according to the conventional credit card transaction process, as in the step S310.

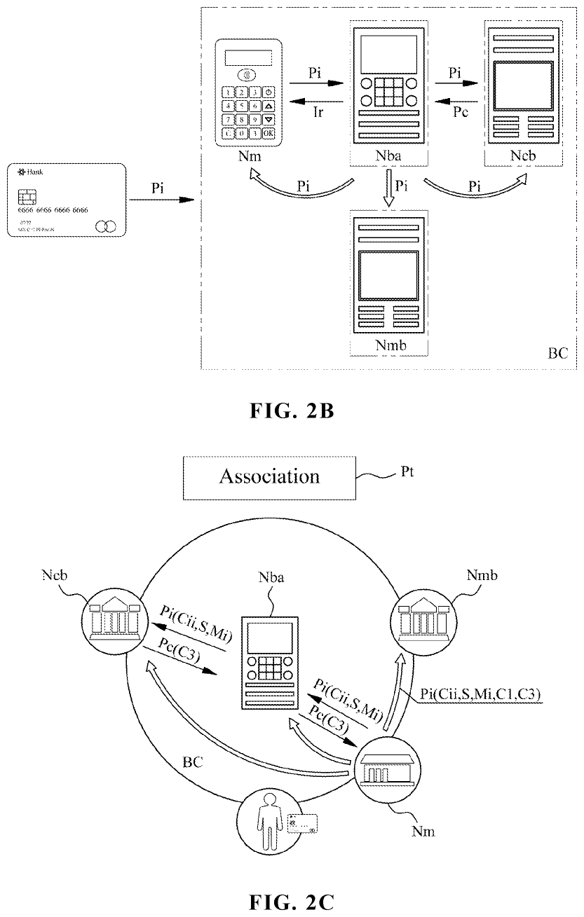

While the process of the first transaction mode is described in detail, reference is made to FIGS. 1A, 1B, 2A, and 2B, in which FIG. 1B is a diagram illustrating a system architecture according to a preferred embodiment of the present invention, FIG. 2A is a diagram schematically illustrating a first transaction mode of a preferred embodiment of the present invention, and FIG. 2B is a diagram illustrating a system architecture used in a first transaction mode of a preferred embodiment of the present invention. First of all, it is noted that the receiving device and the acquiring bank are nodes in the blockchain network BC, i.e. the recipient node Nm and recipient account node Nmb shown in the figures, respectively. The blockchain network BC also includes an intermediary processing node Nba and a payer account node Ncb. The payer account node Ncb serves as the card issuing bank.

Referring to FIG. 1A, in the step S110, when a consumer makes a credit card payment transaction with a credit card, the recipient node Nm (credit card machine) transmits a payment transaction message Pi to the intermediary processing node Nba. The payment transaction message Pi may be data associated with a credit card payment, which includes, for example, a payer identity data item Cii (card number), a transaction amount S, and a recipient account data item Mi. In this embodiment, the payment transaction message Pi further includes a hash function string (message digest), which processes the data associated with the credit card payment by means of a hash algorithm and encrypts it with the private key of the recipient node Nm. The hash function string can only be decrypted by the public key of the recipient node Nm.

The purpose of this is to verify if the sender of the payment transaction message Pi is indeed the recipient node Nm. If it is encrypted by his private key, it can only be decrypted by his public key. By such a manner, his identity can be confirmed. Also, it can be confirmed if the payment transaction message Pi has been tampered with in the path of transmission. If the original payment transaction message Pi processed by a hash algorithm is compared with the aforementioned hash function string and are found consistent with each other, it can be assured that the payment transaction message Pi has not been tampered with.

In this embodiment, the intermediary processing node Nba is a transaction message processing center, which comprises a single server or multiple servers coordinated in operations. In this embodiment, the intermediary processing node Nba includes a processor Mp, a memory module M, and a network interface I. The memory module M stores an application program P and a plurality of payer identity data records Ci. The identity data records Ci are provided by the card issuer (the payer account node Ncb) and are authenticated by the card issuer, so that all legal issues such as identity verification and credibility verification are processed by the card issuer.

In other words, each payer identity data record Ci stored in the memory module M includes the user card number and public key provided by the payer account node Ncb, and the user card number and public key are bound together. The steps as to how the payer account node Ncb provides the payer identity data record Ci are detailed as follows. Firstly, after the payer account node Ncb is added to the blockchain network, the intermediary processing node Nba sends a pass token to the newly added payer account node Ncb. At this time, the payer account node Ncb may transfer the payer identity data records Ci to the intermediary processing node Nba. These payers (users) as identified in the payer identity data records Ci are all certified by KYC (Know Your Customer) for banks in advance, thus the intermediary processing node Nba does not need to review the identities or qualifications of these payers.

In this embodiment, the payer identity data record Ci is associated with a credit card number and a public key for the reason as stated below. It is known that in the operation of the blockchain, a user's public key serves as the user's character. However, in the case of the credit card payment, the swipe message does not include the user's public key. Thus, the card number and the public key need to be linked to each other by the intermediary processing node Nba, so that each node in the blockchain may confirm the user's identity with aid of the intermediary processing node Nba. In addition, as the general users (consumers) do not need to make registration with this system, the user's consumption mode has no difference from that of traditional payment. However, it is noted that, in the present invention, the payer identity data record Ci is not limited to the credit card number. In other modes of transaction, it may be an ID number, a mobile phone number, an e-mail address, biometrics, or other self-defined account number, etc.

On the other hand, in the step S120 as shown in FIG. 1A, the intermediary processing node Nba receives the payment transaction message Pi from the recipient node Nm through the network interface I, and verifies the payer identity data item Cii as included therein. The verification method adopted in the present embodiment is used to determine whether or not the payer identity data item Cii matches with the payer identity data record Ci stored in the memory module M. That is, the intermediary processing node Nba is responsible for preliminarily determining whether or not the consumer associated with the payment transaction message Pi is a qualified (registered) member of the system.

Next, in the step S130 (FIG. 1A), if the intermediary processing node Nba determines that the consumer associated with the payment transaction message Pi is a qualified member of the system, the intermediary processing node Nba sends the payment transaction message Pi to the payer account node Ncb (issuing bank) through the network interface I. If the intermediary processing node Nba determines that the consumer associated with the payment transaction message Pi is not a qualified member of the system, a notification message Ir will be sent to the recipient node Nm which then sends the payment transaction message Pi to a third-party transaction processing institution (such as VISA, Master, JCB, etc.) through the recipient account node Nmb (acquiring bank), and the transaction will be executed based on conventional credit card transaction process (step S300).

After the payer account node Ncb receives the payment transaction message Pi, the payer account node Ncb checks the payer's credit or account balance according to the payer identity data item Cii. If the credit or account balance is greater than the transaction amount, the payer account node Ncb sends a payment transaction confirmation message Pc to the intermediary processing node Nba as illustrated in the step S140 in FIG. 1A. In other words, in addition to verification of the identity of the payer, the card issuing bank also verifies if the payment transaction message Pi is valid. If the verifications are successful, the issuing bank sends a payment transaction confirmation message Pc to the intermediary processing node Nba as illustrated in the step S150 in FIG. 1A.

After the intermediary processing node Nba receives the payment transaction confirmation message Pc transmitted by the payer account node Ncb through the network interface 1, it broadcasts the payment transaction message Pi to the blockchain network BC as illustrated in the step Sf in FIG. 1A. In some embodiments, the payment transaction confirmation message Pc may be composed of the payment transaction message Pi sent from the payer account node Ncb (card issuer) and a confirmation message directly added onto the payment transaction message Pi. Alternatively, a digital signature generated by a private key of the payer account node Ncb may be used as the payment transaction confirmation message Pc.

If the verification of the payment transaction message Pi at the payer account node Ncb fails, the intermediary processing node Nba will send a notification to the recipient node Nm. The payment transaction message Pi is then transmitted to a third-party transaction processing institution through the recipient account node Nmb (acquiring bank), and the transaction will be made according to the conventional credit card transaction process as illustrated in the step S300 in FIG. 1A. However, in some embodiments, the intermediary processing node Nba may directly notify the receiving device (credit card machine) Nm that the credit card payment fails, and the transaction is canceled accordingly.

Finally, the payer account node Ncb allocates funds to the recipient account node Nmb (acquiring bank) in the blockchain network BC according to the payment transaction message Pi, or the recipient account node Nmb (acquiring bank) requests payment from the payer account node Ncb (issuing bank) according to the payment transaction message Pi. The recipient account node Nmb corresponds to the recipient account data item Mi, that is the recipient (seller, merchant) bank account data item associated with the recipient account node Nmb (acquiring bank).

In order to ensure the smoothness of the entire payment transaction, in particularly, this embodiment provides a mechanism for treating time out. After swiping the card, if the recipient node Nm fails to receive the payment transaction message Pi broadcasted by the intermediary processing node Nba within a predetermined time, it is deemed that the consumer associated with the payment transaction message Pi is not a qualified member of the system, and the recipient node Nm will transmit the payment transaction message Pi to a third-party transaction processing institution through the recipient account node Nmb (acquiring bank), and the transaction will be made according to the conventional credit card transaction process as illustrated in the step S300 in FIG. 1A.

In this embodiment, the payment transaction message Pi sent by the recipient node Nm includes not only the payer identity data item Cii (card number), the transaction amount S, and the recipient account data item Mi, but also includes the recipient signature C1, for example, a digital signature generated by the private key of the recipient (recipient node Nm).

In addition, when the payer account node Ncb (issuing bank) confirms that the payment transaction message Pi is valid, the payment transaction confirmation message Pc sent to the intermediary processing node Nba includes the payer account node signature C2 generated by the private key of the payer account node Ncb (issuing bank). This is significant in that, the payment transaction message Pi is not only confirmed by the issuing bank in lieu of the payer, but also has been approved and validated by the issuing bank.

The finally broadcasted payment transaction message Pi includes the recipient signature C1 and the payer account node signature C2. Therefore, the broadcasted payment transaction message Pi has substantially obtained the consents of the buyer, seller, and buyer's card issuing bank, and the associated transaction has become an effective and valid transaction that is reliable, traceable, and non-repudiable.

FIG. 2C is a diagram schematically illustrating another signature method of a preferred embodiment of the present invention. In this embodiment, the private key of the payer is kept by the payer account node Ncb (issuing bank). At the beginning of the credit card transaction, the payment transaction message Pi sent to the intermediary processing node Nba by the recipient node Nm does not include the recipient signature. The payment transaction confirmation message Pc sent by the payer account node Ncb to the intermediary processing node Nba includes the payer signature C3, which is generated by the payer's private key kept by the payer account node Ncb.

In this embodiment, when the intermediary processing node Nba receives the payment transaction confirmation message Pc sent by the payer account node Ncb, the intermediary processing node Nba will not broadcast the message Pi immediately, but transmits the payment transaction confirmation message Pc to the recipient node Nm. Only after a signature is made by the recipient node Nm with the private key of the recipient node Nm, the payment transaction message Pi is broadcasted to the blockchain network BC. In other words, the payment transaction is deemed completed only if the payment transaction message Pi is signed by the recipient node Nm (merchant) with the private key of the recipient node Nm.

Furthermore, in an alternative embodiment of the present invention, where the payer uses a carrier that can store the private key, such as a mobile phone or a chip card (Cool wallet), the transaction can be signed right at the beginning of the transaction with the private key of the payer. In brief, the payment transaction message Pi sent by the recipient node Nm at the beginning may contain a payment transaction confirmation message signed by the payer and the recipient with their respective private keys. That is to say, the payment transaction has obtained the consents of both the buyer and the seller right at the beginning.

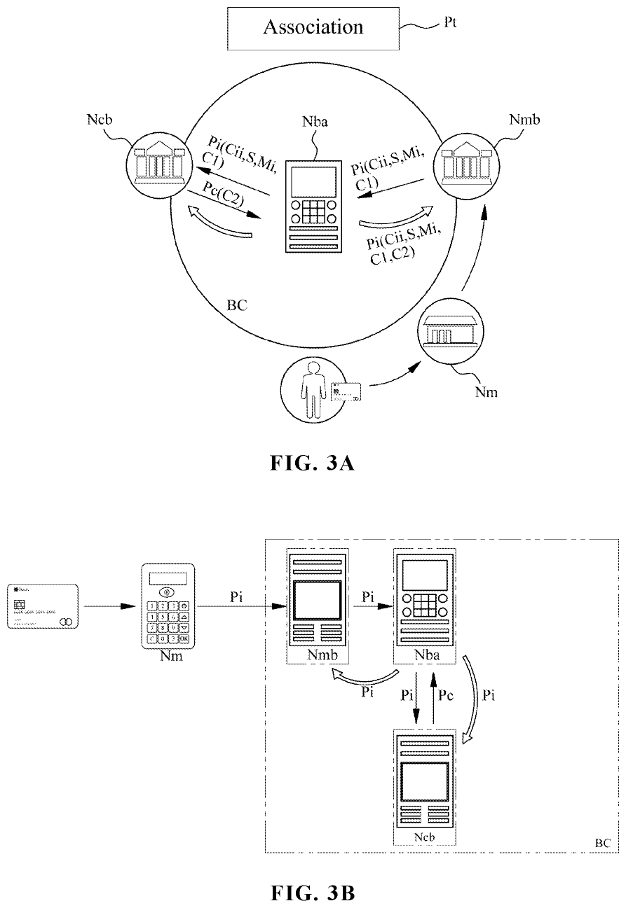

In describing the implementation of a process of the second transaction mode, reference is made to FIGS. 1A, 3A, and 3B, in which FIG. 3A is a diagram schematically illustrating a second transaction mode of a preferred embodiment of the present invention, and FIG. 3B is a drawing illustrating a system architecture of a second transaction mode according to a preferred embodiment of the present invention. It is noted that in the second transaction mode, only the acquiring bank (recipient account node Nmb) is a node in the blockchain network BC, while the credit card machine (recipient node Nm) is not in the blockchain network BC.

As shown in the figures, when the consumer makes a credit card payment transaction, the recipient node Nm transmits a payment transaction message Pi to the recipient account node Nmb, as illustrated in the step S200 in FIG. 1A. Next, the recipient account node Nmb transmits the payment transaction message Pi to the intermediary processing node Nba, as illustrated in the step S110 in FIG. 1A.

Furthermore, in the step S120 of FIG. 1A, after the intermediary processing node Nba receives the payment transaction message Pi from the recipient account node Nmb via the network interface I, the intermediary processing node Nba verifies the payer identity data item Cii of the payer making the payment. The verification method for the first transaction mode is also applicable to the second transaction mode. If the verification of the payer identity data item Cii is successful, the intermediary processing node Nba transmits the payment transaction message Pi to the payer account node Ncb, as illustrated in the step S130 in FIG. 1A. In the step S140, the payer account node Ncb then makes a confirmation of the payment transaction message Pi. The way to confirm the payment transaction message Pi for the first transaction mode is also applicable to the second transaction mode.

In the step S150 (see FIG. 1A), if the payer account node Ncb confirms or approves the payment transaction message Pi, the payer account node Ncb sends the payment transaction confirmation message Pc to the intermediary processing node Nba. Finally, in the Step Sf, the intermediary processing node Nba broadcasts the payment transaction message Pi to the blockchain network BC.

In this embodiment, the issuing bank (payer account node Ncb) and the acquiring bank (recipient account node Nmb) make the signatures with the payer's private key and the recipient's private key, respectively. In an alternative embodiment, the signatures may be made with respective private keys owned by the issuing bank (payer account node Ncb) and the acquiring bank (recipient account node Nmb). In some embodiments, the payment transaction message Pi may be broadcasted by the recipient account node Nmb. That is, after the intermediary processing node Nba receives the payment transaction confirmation message Pc, the intermediary processing node Nba transmits the payment transaction confirmation message Pc to the recipient account node Nmb, and a signature is generated by the recipient account node Nmb with the recipient's private key. The payment transaction message Pi is then broadcasted by the recipient account node Nmb to the blockchain network BC.

The difference between the second and the first transaction modes lies in that the recipient node Nm (credit card machine) is not a node in the blockchain network BC. The reason underlying this difference is that it is very difficult to incorporate all the credit card machines into the blockchain BC of this system. In contrast, it is relatively simple if only the acquiring bank is included in this system.

As given in the above embodiments, this embodiment is based on the conventional credit card payment transaction. As long as the credit card machine (recipient node Nm) or the acquiring bank (recipient account node Nmb) is incorporated into the system, it can be used as a “gateway” for payment transactions in this system. This system would provide fast and safe payment transaction services. More importantly, even if the credit card machine (recipient node Nm) or the acquiring bank (recipient account node Nmb) is not a member of this system, a transaction still can be processed by the conventional credit card payment transaction. In brief, if both the payer and the recipient are members of the system, the system will process the payment transaction, but if one of the payers and recipient is not a member of the system, the conventional transaction can be carried out. In other words, the system according to the present invention would assure the success of the transaction.

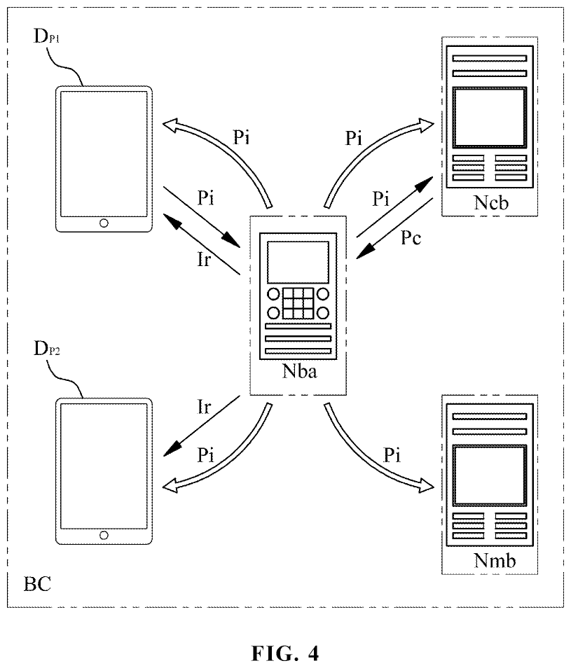

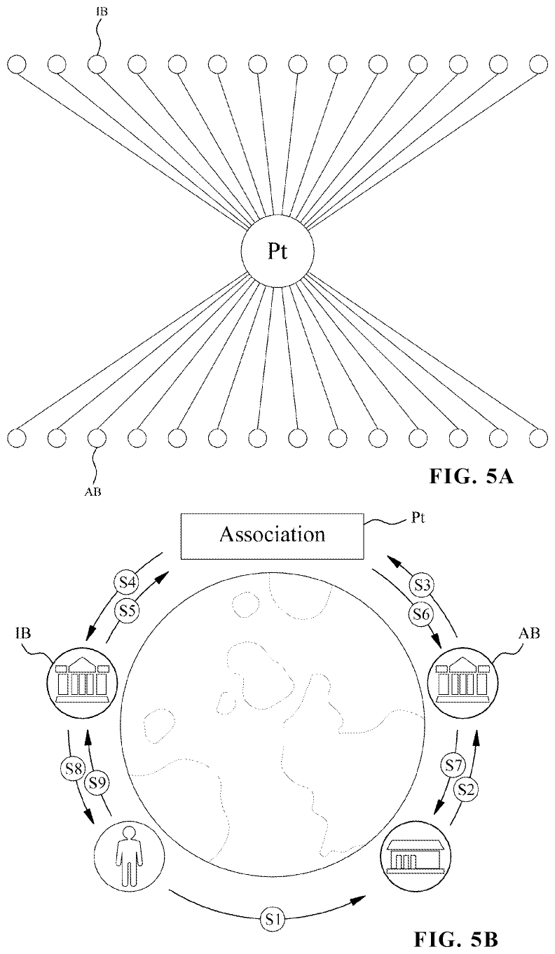

As mentioned above, the present invention shall not be limited to credit card transactions. In describing a mobile payment according to the present invention, reference is made to FIG. 4 which is a drawing illustrating a system architecture of a third transaction mode of a preferred embodiment of the present invention. As shown in the figure, all of a payer mobile device D_{P1}, a recipient mobile device D_{P2}, an intermediary processing node Nba, a payer account node Ncb, and a recipient account node Nmb are members of the blockchain BC of the system. The payer account node Ncb corresponds to the payer's bank, and the recipient account node Nmb corresponds to the recipient's bank.

In this embodiment, the payer mobile device D_{P1} transmits a payment transaction message Pi, which includes a payer account data item, a transaction amount, and a recipient account data item, to the intermediary processing node Nba. Then, the intermediary processing node Nba verifies whether the payer and the recipient of this payment transaction are members of the system. That is to say, the payer account data item and the recipient account data item are verified, and the verification method for above mentioned embodiments is also applicable hereto.

If both the payer and the recipient of this payment transaction are members of the system, the intermediary processing node Nba will transmit the payment transaction message Pi to the payer account node Ncb for checking the credit or account balance of the payer. In case that the credit or account balance is greater than the transaction amount, the payer account node Ncb will send a payment transaction confirmation message Pc to the intermediary processing node Nba.

After the intermediary processing node Nba receives the payment transaction confirmation message Pc, the intermediary processing node Nba broadcasts the payment transaction message Pi to the blockchain network BC. On the other hand, if the payment transaction message Pi is not confirmed or approved by the payer account node Ncb, for example, in the case that the balance or credit is insufficient, the payer account node Ncb will notify the intermediary processing node Nba which will then send a notification message Ir associated with transaction failure to the payer mobile device D_{P1} and the recipient mobile device D_{P2}. Accordingly, the present invention is also applicable to existing mobile payment models. More importantly, the transaction according to this invention is no longer limited to third-party transaction processing institutions, and is more stable, secure, and more private than existing mobile payment models.

It should be understood that the embodiments have been described for illustrative purposes and are not limiting. Accordingly, it is intended that the invention not be limited to the disclosed embodiments, but that it has the full scope permitted by the language of the following claims.

What is claimed is:

1. A system for processing a payment transaction via a blockchain network having at least one recipient node, at least one payer account node, and an intermediary processing node, the intermediary processing node comprising:
a processor;
a memory module configured to store at least one application program; and
a network interface;
wherein the at least one application program includes a plurality of processor-executable instructions that, when executed by the processor, cause the processor to perform a process comprising:
receiving a payment transaction message from the at least one recipient node via the network interface, wherein the payment transaction message includes a payer identity data item of a payer making a payment, a transaction amount, and a recipient account data item;
verifying the payer identity data item, and then transmitting at least the payer identity data item and the transaction amount included in the payment transaction message to the at least one payer account node; and
after receiving, via the network interface, a payment transaction confirmation message sent by the at least one payer account node, either broadcasting the payment transaction message to the blockchain network, or sending the payment transaction message to the at least one recipient node by which the payment transaction message is broadcasted to the blockchain network.

2. The system of claim 1, wherein the at least one payer account node is configured to confirm a credit or account balance of the payer based on the payer identity data item, and send the payment transaction confirmation message to the intermediary processing node if the credit or account balance is found to be greater than the transaction amount.

3. The system of claim 1, wherein the memory module is configured to further store a plurality of payer identity data records provided by the at least one payer account node, and the intermediary processing node is configured to verify if the payer identity data item is consistent with one of the payer identity data records stored in the memory module, and transmit the payment transaction message to the at least one payer account node if the payer identity data item is found consistent with one of the payer identity data records.

4. The system of claim 1, wherein the payment transaction message sent by the at least one recipient node is signed by the at least one recipient node with a private key of the at least one recipient node; and the payment transaction confirmation message is signed by the at least one payer account node with a private key of the at least one payer account node.

5. The system of claim 1, wherein the payment transaction confirmation message sent by the at least one payer account node is signed by the at least one payer account node with a private key of the payer making the payment, and the payment transaction message broadcasted by the at least one recipient node is signed by the at least one recipient node with a private key of the at least one recipient node.

6. A method for processing a payment transaction via a blockchain network, comprising:
a step (A) of providing a payment transaction message to a recipient node in the blockchain network; wherein the payment transaction message includes a payer identity data item of a payer making a payment, a transaction amount, and a recipient account data item;
a step (B) of sending, by the recipient node, the payment transaction message to an intermediary processing node in the blockchain network;
a step (C) of verifying, by the intermediary processing node, the payer identity data item, and then transmitting at least the payer identity data item and the transaction amount included in the payment transaction message to a payer account node in the blockchain network;
a step (D) of confirming, by the payer account node, the payer identity data item and the transaction amount and then sending a payment transaction confirmation message to the intermediary processing node; and
a step (E) of either broadcasting, by the intermediary processing node, the payment transaction message to the blockchain network; or sending, by the intermediary processing node, the payment transaction message to the recipient node, and broadcasting, by the recipient node, the payment transaction message to the blockchain network.

7. The method of claim 6, further comprising a step of sending, by the recipient node, the payment transaction message to a third-party transaction processing institution if the recipient node fails to receive the payment transaction message sent or broadcasted by the intermediary processing node within a specified time.

8. The method of claim 6, wherein the intermediary processing node comprises a memory module, and in the step (C) the intermediary processing node verifies if the payer identity data item is consistent with a payer identity data record stored in the memory module, wherein the payer identity data record stored in the memory module is provided by the payer account node;
the payment transaction message is transmitted by the intermediary processing node to the payer account node if the payer identity data item is found consistent with the payer identity data record; and
if the payer identity data item is found inconsistent with the payer identity data record, a notification message is sent by the intermediary processing node to the recipient node to notify the recipient node to transmit the payment transaction message to a third-party transaction processing institution.

9. The method of claim 6, wherein in the step (A), the payment transaction message is signed by the recipient node with a private key of the recipient node; and in the step (D), the payment transaction confirmation message is signed by the payer account node with a private key of the payer account node.

10. The method of claim 6, wherein in the step (D), the payment transaction confirmation message is signed by the payer account node with a private key of the payer making the payment, and in the step (E), the payment transaction message broadcasted by the recipient node is signed by the recipient node with a private key of the recipient node.

11. The method of claim 6, wherein in the step (D), a credit or account balance of the payer making the payment is confirmed by the payer account node based on the payer identity data item, and the payment transaction confirmation message is sent to the intermediary processing node if the credit or account balance is found to be greater than the transaction amount.

12. The method of claim 6, wherein after the step (E), the method further comprises a step (F) of allocating funds, by the payer account node, to a recipient account node in the blockchain network according to the payment transaction message, wherein the recipient account node corresponds to the recipient account data item.
